(19) United States
(12) Patent Application Publication
(10) Pub. No.: US 2026/0318433 A1
(43) Pub. Date: Oct. 15, 2026

(54) VALVE BLOCK

(71) Applicant: Schaeffler Technologies AG & Co. KG, Herzogenaurach (DE)

(72) Inventors: Julian SCHMID, Gengenbach (DE); Michael ASCHOFF, Bühl (DE)

(73) Assignee: Schaeffler Technologies AG & Co. KG, Herzogenaurach (DE)

(21) Appl. No.: 19/485,540

(22) PCT Filed: May 17, 2024
(86) PCT No.: PCT/DE2024/100462

§ 371 Date: Nov. 18, 2025

(30) Foreign Application Priority Data
May 22, 2023 (DE) 10 2023 113 262.8

(51) Int. Cl. F16K 27/00

(52) U.S. Cl. CPC F16K 27/003

(57) ABSTRACT

A valve block including a valve support having a valve receptacle and two channels leading into the valve receptacle and running in a common plane. The valve receptacle is formed by a valve adapter which is fastened in the valve support and deviates one of the channels in such a way that the channel leads into the valve receptacle outside of the common channel plane.

### CROSS REFERENCE TO RELATED APPLICATIONS

This application is the U.S. National Phase of PCT AppIn. No. PCT/DE2024/100462, filed May 17, 2024, which claims priority to German Patent Application No. 10 2023 113 262.8, filed May 22, 2023, the entire disclosures of which are incorporated by reference herein.

### TECHNICAL FIELD

The disclosure relates to a valve block comprising a valve support with a valve receptacle and two channels leading into the valve receptacle.

### BACKGROUND

Such a valve block is known from U.S. Pat. No. 5,685,164 A.

Battery-electric passenger motor vehicles, hereinafter referred to as BEVs, typically have complex cooling circuits with different operating modes such as heating and cooling of the passenger compartment and cooling of the battery. The required interconnection of valves and connections to other components such as refrigerant compressors and various heat exchangers must be presented in a design that is as compact and integrated as possible. A key component is a valve block for accommodating various refrigerant valves such as expansion valves, shut-off valves or directional control valves.

Previously known designs of the valve block are made up of several parts, in which open, divided channels with valve seats and other functional surfaces are made in a molded plate and either a second half-shell or a flat plate is added to it to form the channels. Here, a very delicate contour must be tightly connected along a large channel section, which, particularly in CO₂ systems with very high pressures, represents a major challenge and involves additional costs.

In addition, there are proposals to produce valve blocks in one piece, although the current concepts require a casting process with a lost core. This also causes high costs and, particularly in CO₂ systems, places very high demands on the casting process due to the high requirements for tightness, cleanliness and pressure resistance.

Due to the design of expansion and shut-off valves in the refrigerant circuit, the inlet and outlet openings of the valves are not at the same (axial) height. As a result, the channels lead into the respective valve receptacle of the valve block at different heights and/or the channels run on different levels, meaning that not all channels can be drilled in alignment or formed by inserts or slides. Rather, such channel geometries again require a multi-part design of the valve block or a casting process with lost cores.

### SUMMARY

It is therefore the object of the disclosure to improve the design of a valve block of the type mentioned at the outset.

This object is achieved in that the channels run in a common channel plane, wherein the valve receptacle is formed by a valve adapter fastened in the valve support, which deviates one of the channels in such a way that one channel leads into the valve receptacle outside the common channel plane. The valve adapter therefore deviates the channel end (at least) of this one channel that leads into the valve receptacle in such a way that the channels correspond to the height offset of the inlet and outlet openings of the valve and can nevertheless be drilled or formed in the same channel plane, which is advantageous for manufacturing purposes. The valve block preferably comprises a valve support with a plurality of valve receptacles and channels leading thereinto, all of which are manufactured in a common channel plane. However, depending on how the valves are connected to each other, it is not necessarily the case that each valve receptacle is formed by a valve adapter.

The valve block can be integrated into an electric axle/electric motor/gearbox housing and would then be part of a larger cast housing.

Advantageous embodiments of the disclosure are the subject matter of the dependent claims.

### BRIEF DESCRIPTION OF THE DRAWINGS

Further features of the disclosure can be found in the following description and the figures, which show exemplary embodiments of the disclosure partially schematically. Unless otherwise mentioned, features or components that are the same or functionally the same are provided with the same reference signs. In the drawing:

FIGS. 1a-c show a portion of a valve block with an expansion valve accommodated therein in various representations;

FIGS. 2a-b show the adapter according to FIG. 1 in two views;

FIGS. 3a-b show the valve block according to FIGS. 1a-c with a row of expansion valves accommodated therein in various representations;

FIGS. 4a-b show a valve block with several rows of expansion valves accommodated therein in different representations;

FIGS. 5a-d show a further valve block with several expansion valves accommodated therein in different representations;

FIGS. 6 a-c show a valve block with a 3/2-way valve accommodated therein in different representations;

FIGS. 7a-b show the adapter according to FIG. 6 in two views.

### DETAILED DESCRIPTION

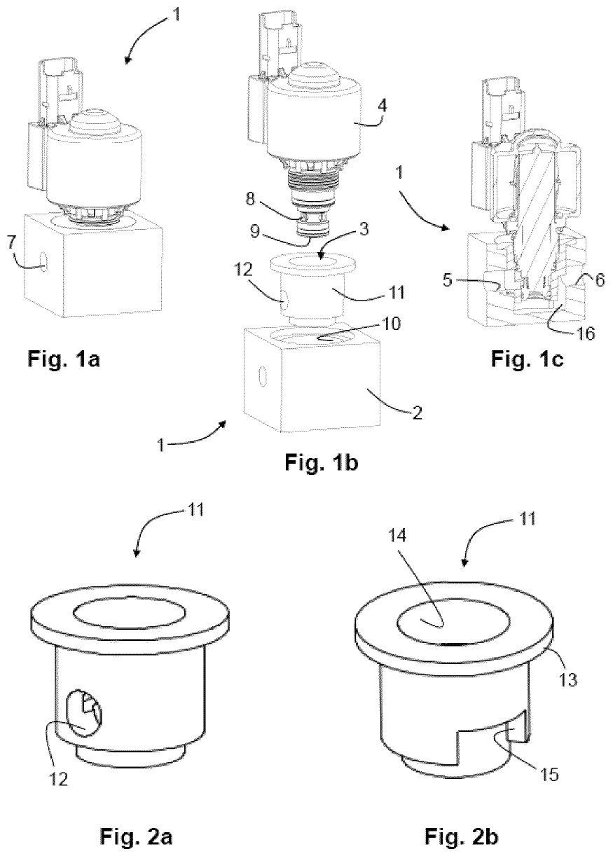

FIGS. 1a to 1c each show in perspective a portion of a valve block 1 in the assembled state, in an exploded view and in longitudinal section, respectively. The valve block 1 comprises a valve support 2 with a valve receptacle 3 and a valve 4 accommodated therein, which in the present case is an expansion valve of a CO₂ refrigeration circuit of a BEV. The supply and discharge of the refrigerant at the valve 4 takes place via channels 5 and 6, which are aligned with each other in a common channel plane and are created by a single longitudinal bore 7 passing through the valve support 2. The valve 4 has transverse bores 8 as inlet opening and a longitudinal bore 9 which leads axially at an offset height thereto as outlet opening. This height offset is compensated by a valve adapter 11 fastened in a receiving bore 10 of the valve support 2, which valve adapter forms the valve receptacle 3 and deviates the outlet-side channel 6 towards the bottom of the receiving bore 10, so that the channel 6 leads into the valve receptacle 3 outside the common channel plane. The leading of the inlet-side channel 5 in the valve receptacle 3 lies in the channel plane and is formed by a transverse bore 12 of the valve adapter 11 aligned with the channel 5.

The valve adapter 11, which is shown in FIGS. 2a and 2b as an enlarged individual part and is secured circumferentially and sealingly in the receiving bore 10, is designed as a sleeve which rests with a collar 13 in the correspondingly stepped receiving bore 10 and has an internal thread 14 for the valve 4 screwed into it. The sealing attachment of the valve adapter can be achieved by a press, weld and/or solder connection. The inlet-side transverse bore 12 is shown in FIG. 2a. The outlet-side channel deviation is formed by a recess 15 in the outer circumference of the valve adapter 11, said recess extending only partially circumferentially. The recess 15 is dimensioned circumferentially and axially such that the refrigerant emerging from the longitudinal bore 9 flows around the bore-side end face of the valve adapter 11 into the recess 15 and from there into the channel 6 aligned with the recess 15. The receiving bore 10 also has a circumferential local recess 16 in order to increase the deviation cross-section through which the refrigerant flows.

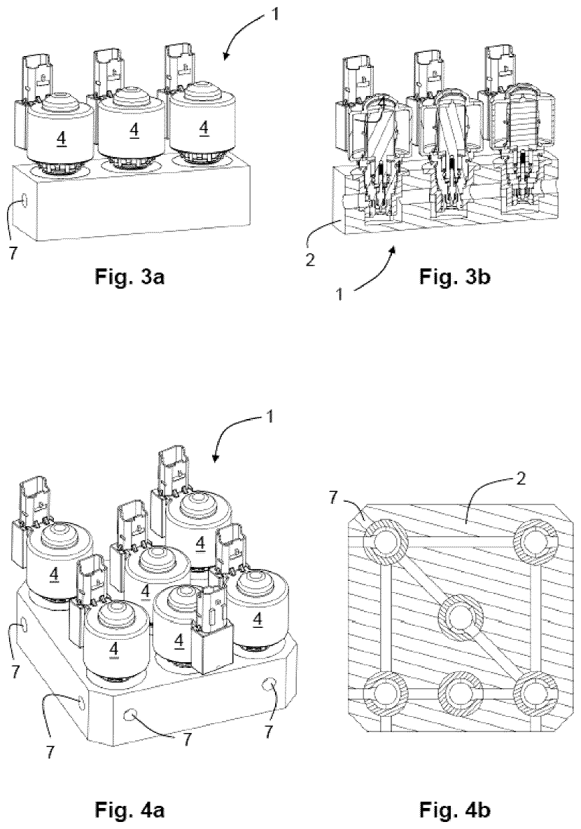

FIGS. 3a and 3b show the valve block 1 with a row of valves 4 accommodated therein in the assembled state and in longitudinal section, respectively. The row consists of three valves 4 and can in principle have any number of valves. The longitudinal bore 7 passing through the valve support 2 can also be seen in the sectional view according to FIG. 3b.

FIGS. 4a and 4b show a valve block 1 with several rows of valves 4 accommodated therein in the assembled state and in cross-section through the valve support 2. In principle, any number of valve rows with any number of valves can be provided. In the illustrated exemplary embodiment, the valve support 2 is provided with five longitudinal bores 7 running in the common channel plane.

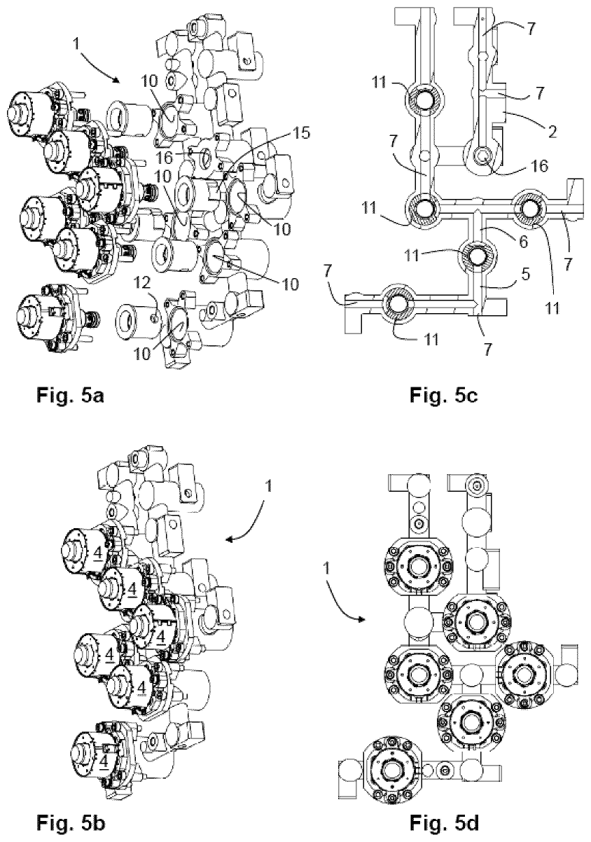

FIGS. 5a to 5d show a further valve block 1 with a branched valve support 2 and a plurality of valves 4 accommodated therein in an exploded view, in the assembled state, in cross section through the valve support 2 and in plan view, respectively. In contrast to the receiving bores 10, the receiving bore 16 is not lined with a valve adapter 11, since the lower channel is only led out with an external interface. The ends of the longitudinal bores 7 running in the common channel plane are all unsealed. In this exemplary embodiment, different valve adapters 11 are required, which differ from one another depending on the mutual orientation of the channels 5, 6 by the circumferential relative position, i.e., either 90° or 180° angular distance of the transverse bore 12 to the recess 15. Compared to the previous exemplary embodiments, the valves 4 are not fastened to the valve support 2 in the valve adapters 11 by means of a central thread, but by means of a flange screw connection.

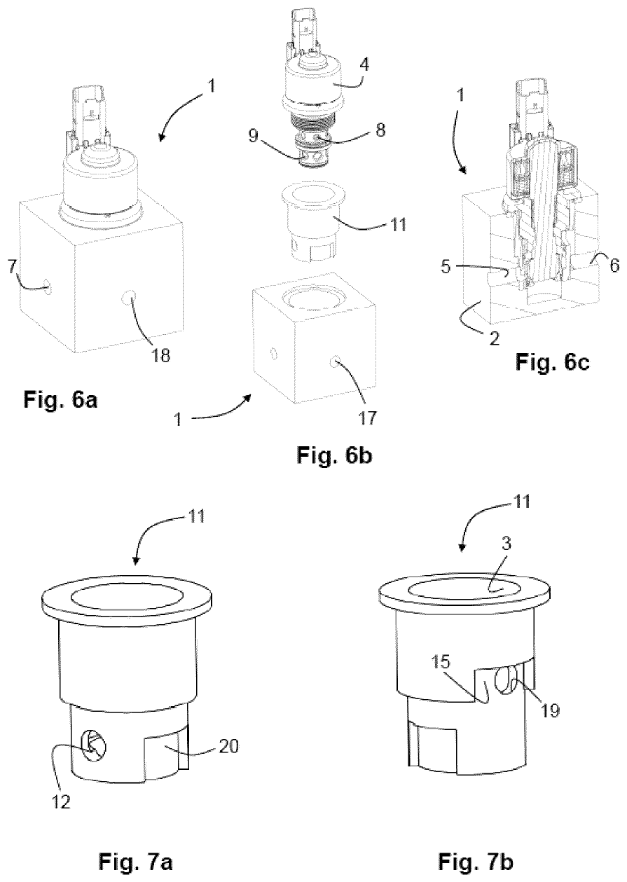

FIGS. 6a to 6c show, analogously to FIGS. 1a to 1c, a portion of a valve block 1, wherein the valve 4 shown here is a 3/2-way valve of a CO₂ refrigeration circuit of a BEV. The refrigerant is supplied to the valve 4 via the channel 5 and the refrigerant is removed from the valve 4, depending on its switching position, either via the channel 6 and a third channel 17 permanently connected to the channel 5 or only via the channel 17. All three channels 5, 6 and 17 are aligned with each other in the common channel plane and are created by the longitudinal bore 7 and a transverse bore 18, running orthogonally thereto, in the valve support 2.

The valve 4 has transverse bores 8 as outlet opening to the channel 6 and transverse bores 9, offset in height axially thereto, as inlet opening. As is clear from FIGS. 7a and 7b, the valve adapter 11, which compensates for the height offset and is also a sleeve, has the transverse bore 12 aligned with the inlet-side channel 5 and, in the outer circumference of the sleeve, a further recess 20 offset circumferentially by 90° to this as a channel deviation of the third channel 17 as well as a further transverse bore 19 on the outlet side, which together with the recess 15 in the outer circumference of the valve adapter 11 deviates the mouth of the channel 6 in the valve receptacle 3 out of the common channel plane. The channel deviation of the channel 6 via the recess 15 and the channel deviation of the third channel 17 via the further recess 20 are axially opposite. The further recess 20, which also extends only partially circumferentially around the outer circumference of the sleeve, can alternatively be replaced by a further transverse bore.

1. A valve block, comprising:
a valve support with a valve receptacle and first and second channels leading into the valve receptacle,
wherein the first and second channels run in a common channel plane, and the valve receptacle is formed by a valve adapter fastened in the valve support, which deviates one of the first and second channels in such a way that the first channel leads into the valve receptacle outside the common channel plane.

2. The valve block according to claim 1, wherein the second channel leads into the valve receptacle in the common channel plane.

3. The valve block according to claim 2, wherein the valve adapter is designed as a sleeve which deviates the first channel via a recess in an outer circumference of the sleeve, said recess extending only partially circumferentially.

4. The valve block according to claim 3, wherein the second channel leads into a transverse bore of the sleeve in the valve receptacle.

5. The valve block according to claim 3, wherein the valve support has a third channel leading into the valve receptacle, which third channel runs in the common channel plane and which the valve adapter deviates in such a way that the third channel leads into the valve receptacle outside the common channel plane.

6. The valve block according to claim 5, wherein the sleeve deviates the third channel via a further recess in the outer circumference of the sleeve, said further recess extending only partially circumferentially.

7. The valve block according to claim 6, wherein the first channel leads into a further transverse bore of the sleeve in the valve receptacle.

8. The valve block according to claim 1, wherein a valve is fixed in the valve receptacle.

9. The valve block according to claim 1, wherein the channels are drilled.

10. A valve block, comprising:
a valve support with a valve receptacle and first and second channels leading into the valve receptacle; and
a valve fixed in the valve receptacle;
wherein the first and second channels run in a common channel plane, and the valve receptacle is formed by a valve adapter fastened in the valve support, which deviates one of the first and second channels in such a way that the first channel leads into the valve receptacle outside the common channel plane.

11. The valve block according to claim 10, wherein the second channel leads into the valve receptacle in the common channel plane.

12. The valve block according to claim 11, wherein the valve adapter is designed as a sleeve which deviates the first channel via a recess in an outer circumference of the sleeve, said recess extending only partially circumferentially.

13. The valve block according to claim 12, wherein the second channel leads into a transverse bore of the sleeve in the valve receptacle.

14. The valve block according to claim 12, wherein the valve support has a third channel leading into the valve receptacle, which third channel runs in the common channel plane and which the valve adapter deviates in such a way that the third channel leads into the valve receptacle outside the common channel plane.

15. The valve block according to claim 14, wherein the sleeve deviates the third channel via a further recess in the outer circumference of the sleeve, said further recess extending only partially circumferentially.

16. The valve block according to claim 15, wherein the first channel leads into a further transverse bore of the sleeve in the valve receptacle.

17. The valve block according to claim 10, wherein the valve includes at least one inlet opening and at least one outlet opening, wherein the at least one inlet opening is disposed axially offset from the at least one outlet opening.

18. The valve block according to claim 17, wherein the at least one inlet opening is disposed transverse to an axis of the valve, and the at least one outlet opening is disposed parallel with the axis of the valve.
